(19) United States
(12) Patent Application Publication
(10) Pub. No.: US 2026/0104614 A1
(43) Pub. Date: Apr. 16, 2026

(54) ELECTROCHROMIC MEDIUM COMPOSITION AND PREPARATION METHOD THEREOF, AND ELECTROCHROMIC DEVICE

(71) Applicant: Vallight Optics Technology Ningbo Co., Ltd., Ningbo City (CN)

(72) Inventors: Kun Li, Ningbo City (CN); Zijian Deng, Ningbo City (CN); Juanjuan Yun, Ningbo City (CN); Shuting Wang, Ningbo City (CN); Jinhui Yang, Ningbo City (CN)

(21) Appl. No.: 19/326,401

(22) Filed: Sep. 11, 2025

(30) Foreign Application Priority Data
Oct. 12, 2024 (CN) 202411420009.8

(51) Int. Cl. G02F 1/1516

(52) U.S. Cl. CPC G02F 1/1516

(57) ABSTRACT

Provided are an electrochromic medium composition and a preparation method thereof, and an electrochromic device. The electrochromic medium composition includes at least two anodic electrochromic materials and one cathodic electrochromic material, where a molar ratio of the at least two anodic electrochromic materials to the one cathodic electrochromic material is in a range of 1:0.5 to 1:1.5; the one cathodic electrochromic material includes an electrochromic material capable of absorbing yellow light; and the at least two anodic electrochromic materials include an electrochromic material capable of absorbing blue light and red light and an electrochromic material capable of absorbing green light, and the electrochromic material capable of absorbing the green light is selected from compounds represented by the following structural formula.

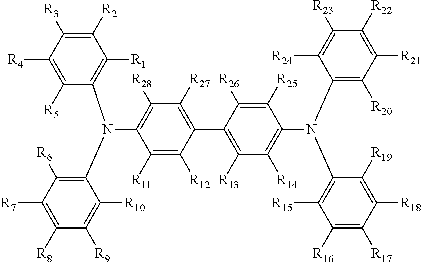

### CROSS REFERENCE TO RELATED APPLICATION

This patent application claims the benefit and priority of Chinese Patent Application No. 202411420009.8 filed with the China National Intellectual Property Administration on Oct. 12, 2024, the disclosure of which is incorporated by reference herein in its entirety as part of the present application.

### TECHNICAL FIELD

The present disclosure relates to the technical field of electrochromic materials, and in particular to an electrochromic medium composition and a preparation method thereof, and an electrochromic device.

### BACKGROUND

Electrochromism refers to the phenomenon where the optical properties (such as reflectivity, transmittance, absorptivity, etc.) of a material undergo stable and reversible color changes under an applied electric field, which visually manifests as reversible changes in color and transparency.

Based on the reaction mechanism during electrochromism, electrochromic materials can be classified into anodic electrochromic materials and cathodic electrochromic materials. Currently, cathodic electrochromic materials are primarily viologens and derivatives thereof, and anodic electrochromic materials are predominantly represented by ferrocene, triphenylamine, phenazines, phenothiazines, and derivatives thereof. Among them, the phenazine-viologen electrochromic system is currently the most commonly used red-blue electrochromic combination. However, although such an electrochromic system exhibits a better absorption effect for red and blue colors, it shows poor sensitivity to green light, resulting in a persistent greenish appearance in devices prepared by using the system. Consequently, when the electrochromic material is used in cameras or other photochromic smart glass, the observed color of objects may become distorted. Therefore, there is an urgent need to improve the phenazine-viologen electrochromic system, allowing the electrochromic system to exhibit a more neutral (gray-like) color.

In view of this, the present disclosure is proposed.

### SUMMARY

An object of the present disclosure is to provide an electrochromic medium composition and a preparation method thereof, and an electrochromic device. The electrochromic medium composition provided in an embodiment of the present disclosure can achieve a neutral “gray” color state, further extending the application of the electrochromic medium composition.

The present disclosure is implemented as follows:

In a first aspect, the present disclosure provides an electrochromic medium composition, including at least two anodic electrochromic materials and one cathodic electrochromic material, where
a molar ratio of the anodic electrochromic materials to the cathodic electrochromic material is in a range of 1:0.5 to 1:1.5;
the one cathodic electrochromic material includes an electrochromic material capable of absorbing yellow light;
the at least two anodic electrochromic materials include an electrochromic material capable of absorbing blue light and red light and an electrochromic material capable of absorbing green light, and the electrochromic material capable of absorbing the green light is selected from compounds represented by the following structural formula:

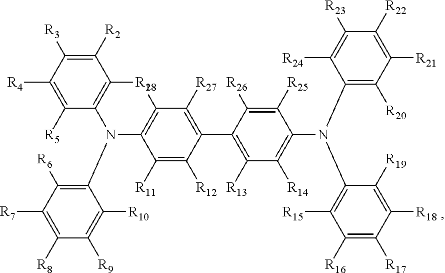

where, R₁ to R₂₈ are each independently any one selected from the group consisting of hydrogen, halogen, cyano, nitro, C1-C5 substituted or unsubstituted alkyl and OR′, or R₁₂ and R₁₃ link together to form a ring, or R₂₆ and R₂₇ link together to form a ring; where R′ is any one selected from the group consisting of C1-C5 unsubstituted alkyl, C6-C10 aryl, and amino; and

a molar ratio of the electrochromic material capable of absorbing the blue light and the red light to the electrochromic material capable of absorbing the green light is in a range of 1:0.5 to 1:2.5.

In a second aspect, the present disclosure provides a method for preparing the electrochromic medium composition as described in the above embodiments, including: mixing the at least two anodic electrochromic materials and the one cathodic electrochromic material.

In a third aspect, the present disclosure provides an electrochromic device, including the electrochromic medium composition as described in the above embodiments.

Some embodiments of the present disclosure have the following beneficial effects: In the embodiments, by selecting an electrochromic material capable of absorbing yellow light, an electrochromic material capable of absorbing blue light and red light, and an electrochromic material capable of absorbing green light, and by defining a molar ratio of the electrochromic material capable of absorbing green light and the cathodic and anodic electrochromic materials, the perfect adjustment of the “neutral gray” is achieved by the electrochromic medium composition, thus enabling the electrochromic device to achieve full coverage of the visible light spectrum.

### DETAILED DESCRIPTION OF THE EMBODIMENTS

In order to make the objects, technical solutions, and advantages of the present disclosure clearer, the technical solutions in the embodiments of the present disclosure will be clearly and completely described below. The embodiments in which specific conditions are not specified are carried out under conventional conditions or conditions recommended by the manufacturer. The reagents or instruments used for which manufacturers are not specified are all conventional commercially available products.

In an embodiment of the present disclosure, an electrochromic medium composition includes at least two anodic electrochromic materials and one cathodic electrochromic material, where a molar ratio of the at least two anodic electrochromic materials to the one cathodic electrochromic material is in a range of 1:0.5 to 1:1.5; for example, the molar ratio is 1:0.5, 1:0.6, 1:0.7, 1:0.8, 1:0.9, 1:1, 1:1.1, 1:1.2, 1:1.3, 1:1.4, 1:1.5, etc., or any value between 1:0.5 to 1:1.5 or in a range between any two of these values. By adjusting the molar ratio of the cathodic electrochromic materials to the anodic electrochromic material, the shade of the color of the electrochromic medium composition may be adjusted to achieve a neutral gray color effect in the electrochromic device.

In some embodiments, a concentration of the anodic electrochromic materials in the electrochromic medium composition is in a range of 1 mM to 100 mM, for example, 1 mM, 5 mM, 10 mM, 20 mM, 35 mM, 40 mM, 50 mM, 60 mM, 70 mM, 80 mM, 90 mM, 100 mM, etc., or any value between 1 mM to 100 mM or in a range between any two of these values, for example, 10 mM to 50 mM, more preferably 30 mM to 35 mM. The specific concentration may be selected based on the required contrast ratio in the visible light range.

In some embodiments, a concentration of the cathodic electrochromic material in the electrochromic medium composition is in a range of 1 mM to 100 mM, for example, 1 mM, 5 mM, 10 mM, 20 mM, 35 mM, 40 mM, 50 mM, 60 mM, 70 mM, 80 mM, 90 mM, 100 mM, etc., or any value between 1 mM to 100 mM or in a range between any two of these values, for example, 10 mM to 50 mM, more preferably 35 mM to 40 mM. The specific concentration may be selected based on the required contrast ratio in the visible light range.

In some embodiments, the cathodic electrochromic material includes an electrochromic material capable of absorbing yellow light, for example, viologen-based electrochromic materials such as small-molecule viologen derivatives (including, in particular but not limited to methyl viologen, ethyl viologen, n-propyl viologen, isopropyl viologen, benzyl viologen, etc.), and viologen-based functional conjugated polymers (e.g., pendant-type viologen materials whose backbones are polyvinyl alcohol, polymethacrylate, polyethylene, and polystyrene, respectively).

In some embodiments, the at least two anodic electrochromic materials include an electrochromic material capable of absorbing blue light and red light and an electrochromic material capable of absorbing green light, where a molar ratio of the electrochromic material capable of absorbing the blue light and the red light to the electrochromic material capable of absorbing the green light is in a range of 1:0.5 to 1:2.5, for example 1:0.5, 1:0.8, 1:1, 1:1.2, 1:1.5, 1:1.8, 1:2, 1:2.5, etc., or any value between 1:0.5 to 1:2.5 or in a range between any two of these values. For example, 1:1.5 to 1:1.8. Further control of the ratio of the two enables the electrochromic device to achieve a neutral gray color effect.

In some embodiments, the electrochromic material capable of absorbing the blue light and the red light is selected from phenazine-based electrochromic materials, for example, including but not limited to 5,10-dimethyldihydrophenazine, 5,10-diethyldihydrophenazine, and 5,10-dibenzyl-5,10-dihydrophenazine.

In some embodiments, the electrochromic material capable of absorbing the green light is selected from compounds represented by the following structural formula:

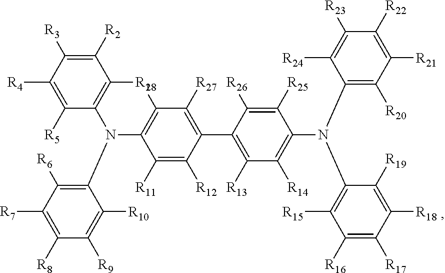

where, R₁ to R₂₈ are each independently any one selected from the group consisting of hydrogen, halogen, cyano, nitro, C1-C5 substituted or unsubstituted alkyl and OR′, or R₁₂ and R₁₃ link together to form a ring, or R₂₆ and R₂₇ link together to form a ring; where R′ is any one selected from the group consisting of C1-C5 unsubstituted alkyl, C6-C10 aryl, and amino.

In specific embodiments, the halogen includes any one selected from the group consisting of F, Cl, Br, and I.

In some embodiments, the C1-C5 alkyl includes, but is not limited to, methyl, ethyl, isopropyl, n-propyl, t-butyl, n-butyl, isopentyl, n-pentyl, t-pentyl and other branched or linear alkyl groups. For example, C1-C3 unsubstituted alkyl is preferred.

In some embodiments, the substituents as described above mean that one or more hydrogens on any carbon in the alkyl group or a plurality of hydrogens on multiple carbons are substituted with a group, where the group is halogen, nitro, cyano, alkoxy, etc.

In some embodiments, the C6-C10 aryl include, but are not limited to, phenyl, benzyl, or alkyl-substituted phenyl.

In some embodiments, R₁₂ and R₁₃ link together to form the ring, and the ring includes an oxygen-containing heterocycle; or R₂₆ and R₂₇ link together to form the ring, and the ring includes an oxygen-containing heterocycle.

Furthermore, in the embodiments of the present disclosure, a specific compound capable of absorbing green light is selected to achieve a red-colored state, and forms a ternary system with an electrochromic material capable of absorbing yellow light and an electrochromic material capable of absorbing blue light and red light (e.g., a phenazine-viologen system), thus achieving full-wavelength coverage of visible light in the colored state. Further, the selection of R is controlled to control the solubility of the above electrochromic material, so that the concentration of the electrochromic material capable of absorbing green light in the electrochromic medium composition is appropriate.

In specific embodiments, the electrochromic material capable of absorbing the green light is any one selected from the group consisting of compounds represented by the following structural formulae:

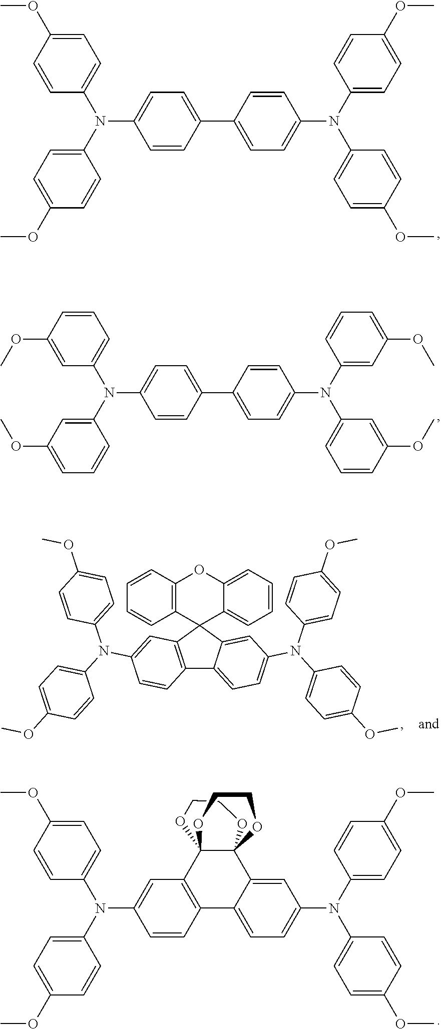

In some embodiments, the electrochromic medium composition further includes at least one selected from the group consisting of a solvent, an ultraviolet absorption stabilizer, a thickener, and a buffer solution. In some embodiments, the solvent includes, but is not limited to, a propylene carbonate (PC) solution, T-butyrolactone, dimethyl sulfoxide (DMSO), N-methylpyrrolidone (NMP), and the like, and the thickener includes, but is not limited to, polymethyl methacrylate, polyvinylpyrrolidone, etc. The amounts of the above substances are in a range commonly used in the prior art and will not be described in detail in the embodiments of the present disclosure.

In a second aspect, the present disclosure provides a method for preparing the electrochromic medium composition as described in the above embodiments, including: mixing the at least two anodic electrochromic materials and the one cathodic electrochromic material. The specific mixing conditions, such as the mixing time and temperature, are those in the prior art and will not be described in detail in the embodiments of the present disclosure.

In specific embodiments, the electrochromic material capable of absorbing the green light is synthesized by a Buchwald-Hartwig cross-coupling reaction, and the synthesis route is as follows:

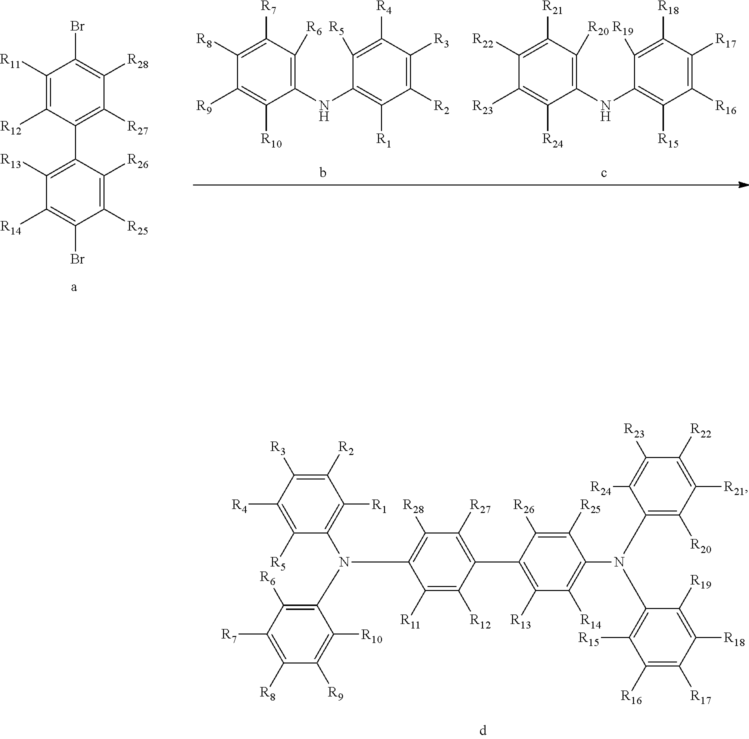

for example,

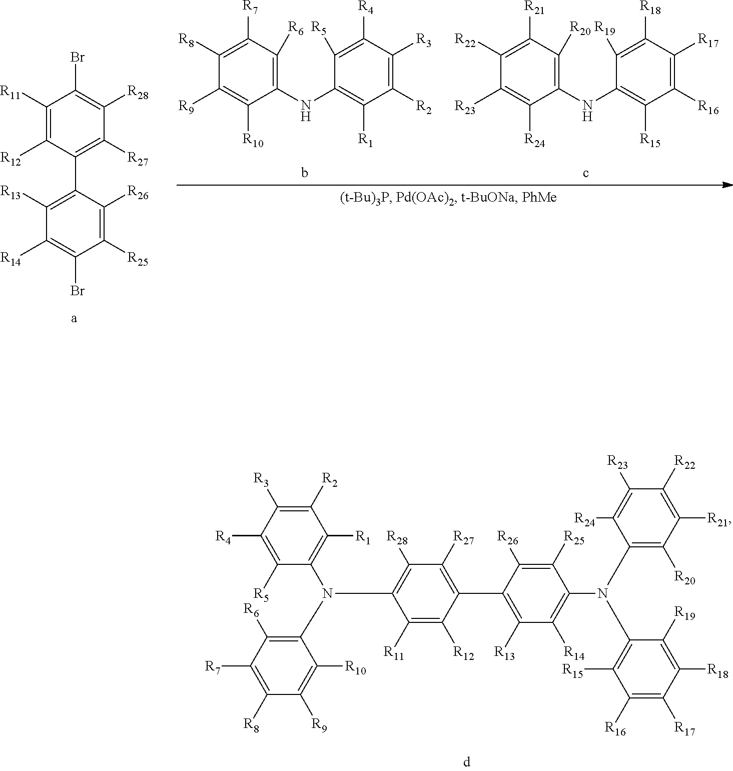

where feeding amounts of reaction materials are as follows: 1 equivalent of compound a, 1 equivalent to 1.1 equivalents of compound b, 1 equivalent to 1.1 equivalents of compound c, 2.0 equivalents to 2.5 equivalents of a sodium alkoxide material (e.g., sodium tert-butoxide (t-BuOK)), 0.02 equivalents to 0.05 equivalents of alkylphosphine (e.g., tri-tert-butylphosphine ((t-Bu)₃P)), and 0.005 equivalents to 0.02 equivalents of a palladium catalyst (e.g., palladium acetate (Pd(OAc)₂); and a reaction temperature is in a range of 100° C. to 120° C.

In a third aspect, the present disclosure provides an electrochromic device, including the electrochromic medium composition as described in the above embodiments.

The characteristics and performance of the present disclosure will be further described in detail below with reference to the examples.

### Synthesis Example 1

In this synthesis example, provided was a red electrochromic material (compound 1) capable of absorbing green light, which had a structural formula as follows:

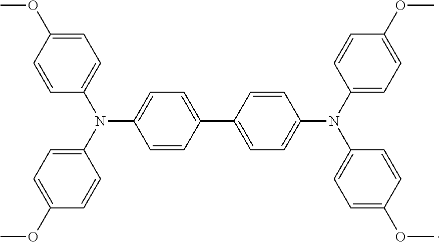

The synthesis procedures of compound 1 were as follows: In a two-neck round-bottom flask, 3.82 g of 4,4′-dimethoxydiphenylamine, 2.50 g of 4,4′-dibromobiphenyl, 1.92 g of sodium tert-butoxide, 72 mg of palladium acetate, 52 mg of tri-tert-butylphosphine, and 20 mL anhydrous toluene were added and heated to reflux for reaction under an N₂ atmosphere, and the progress of the reaction was monitored by thin-layer chromatography. After the reaction of raw materials was complete, a resulting system was cooled to room temperature, a resulting organic phase was washed three times with 100 mL of saturated NaCl solution and was distilled under reduced pressure to obtain a crude product, and the crude product was purified by column chromatography (mobile phase: petroleum ether/dichloromethane=2/1) to obtain 4.28 g of compound 1 (yield: 88%).

Characterization data: ¹H NMR (500 MHz, DMSO-d₆): δ 7.38 (d, J=8.3 Hz, 4H), 7.01 (d, J=8.3 Hz, 8H), 6.89 (d, J=8.3 Hz, 8H), 6.80 (d, J=8.3 Hz, 4H), 3.73 (s, 12H).

### Synthesis Example 2

In this synthesis example, provided was a red electrochromic material (compound 2) capable of absorbing green light, which had a structural formula as follows:

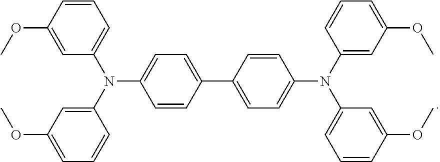

The synthesis procedures of compound 2 were as follows: In a two-neck round-bottom flask, 3.82 g of 3,3′-dimethoxydiphenylamine, 2.50 g of 4,4′-dibromobiphenyl, 1.92 g of sodium tert-butoxide, 72 mg of palladium acetate, 52 mg of tri-tert-butylphosphine, and 20 mL anhydrous toluene were added and heated to reflux for reaction under an N₂ atmosphere, and the progress of the reaction was monitored by thin-layer chromatography. After the reaction of raw materials was complete, a resulting system was cooled to room temperature, a resulting organic phase was washed three times with 100 mL of saturated NaCl solution and was distilled under reduced pressure to obtain a crude product, and the crude product was purified by column chromatography (mobile phase: petroleum ether/dichloromethane=2/1) to obtain 4.28 g of compound 2 (yield: 82%).

Characterization data: ¹H NMR (500 MHz, CDCl₃): δ 7.48 (d, J=8.3 Hz, 4H), 7.16-7.19 (m, 8H), 6.73-6.74 (m, 8H), 6.61 (d, J=8.3 Hz, 4H), 3.75 (s, 12H).

### Synthesis Example 3

In this synthesis example, provided was a red electrochromic material (compound 3) capable of absorbing green light, which had a structural formula as follows:

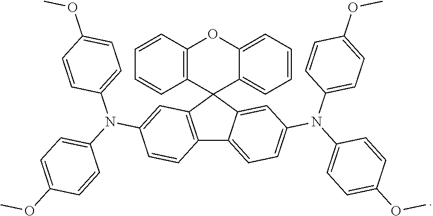

The synthesis procedures of compound 3 were as follows:

A mixture of 9.41 g of phenol, 3.38 g of 2,7-dibromo-9H-fluoren-9-one, and 2.6 ml of methanesulfonic acid was subjected to reaction by heating at 150° C. for 24 hours. After a resulting reaction system was cooled to room temperature, 100 ml of methanol was slowly added to the system, a resulting white precipitate was filtered and washed with a large amount of methanol, obtaining 4.42 g of intermediate 1 (yield: 90%).

The structural formula of intermediate 1 was as follows:

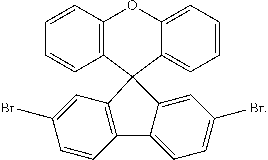 [SMILES: Brc1ccc2c(c1)C1(c3ccccc3Oc3ccccc31)c1cc(Br)ccc1-2]

Characterization data for intermediate 1: ¹H NMR (500 MHz, (CD₃)₂CO, 298 K, 6): 7.96 (d, J=10 Hz, 2H), 7.63 (d, J=10 Hz, 2H), 7.30-7.28 (m, 6H), 6.91˜6.87 (m, 2H), 6.41 (d, J=10 Hz, 2H).

0.76 g of 4,4′-dimethoxydiphenylamine, 0.74 g of 2,7-dibromospiro[fluorene-9,9′-oxanthene], and 0.92 g of NaOtBu were added to 30 mL of anhydrous toluene. A resulting solution was bubbled with nitrogen several times, and then 12 mg P(t-Bu)₃ and 14 mg Pd(OAc)₂ were added thereto, and a resulting mixture was refluxed for reaction overnight. After the reaction of raw materials was complete, a resulting system was cooled to room temperature, a resulting organic phase was washed three times with 100 mL of saturated NaCl solution and was distilled under reduced pressure to obtain a crude product, and the crude product was purified by column chromatography (mobile phase: petroleum ether/ethyl acetate=1/1) to obtain 1.0 g of compound 3 (yield: 85%).

Characterization data for compound 3: ¹H NMR (500 MHz, DMSO-d₆, 298 K, 6): 7.58 (d, J=10 Hz, 2H), 7.24 (t, J=5 Hz, 2H), 7.13 (d, J=10 Hz, 2H), 6.95 (t, J=10 Hz, 2H), 6.86-6.72 (m, 18H), 6.48 (d, J=10 Hz, 4H), 3.68 (s, 12H).

### Synthesis Example 4

In this synthesis example, provided was a red electrochromic material (compound 4) capable of absorbing green light, which had a structural formula as follows:

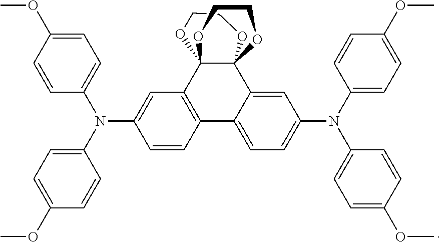

The synthesis procedures of compound 4 were as follows:

A mixture of 3.66 g of 2,7-dibromophenanthrenequinone, 2 ml of ethylene glycol, and 2.6 ml of methanesulfonic acid was refluxed for reaction in 50 mL of methanol for 24 hours. A resulting reaction system was cooled to room temperature, then a solvent was evaporated to dryness, and a resulting system was washed three times with 100 mL of saturated NaCl solution to obtain a crude product. The crude product was purified by column chromatography (mobile phase: petroleum ether/ethyl acetate=1/1) to obtain 3.8 g of intermediate 2 (yield: 84%).

The structural formula of intermediate 2 was as follows:

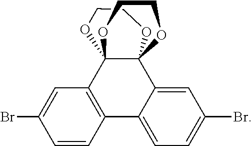

Characterization data for intermediate 2: ¹H NMR (400 MHz, CDCl₃) δ: 7.88 (d, 2H, J=2.0 Hz), 7.71 (d, 2H, J=8.4 Hz), 7.59 (dd, 2H, J1=8.4 Hz, J2=2.0 Hz), 4.22 (bs, 4H), 3.67 (bs, 4H).

0.76 g of 4,4′-dimethoxydiphenylamine, 0.70 g of intermediate 2, and 0.92 g of NaOtBu were added to 30 mL of anhydrous toluene. A resulting solution was bubbled with nitrogen several times, and then 12 mg P(t-Bu)₃ and 14 mg Pd(OAc)₂ were added thereto, and a resulting mixture was refluxed for reaction overnight. After the reaction of raw materials was complete, a resulting system was cooled to room temperature, a resulting organic phase was washed three times with 100 mL of saturated NaCl solution and was distilled under reduced pressure to obtain a crude product, and the crude product was purified by column chromatography (mobile phase: petroleum ether/ethyl acetate=1/1) to obtain 0.97 g of compound 4 (yield: 84%).

Characterization data for compound 4: ¹H NMR (400 MHz, CDCl₃) δ: 7.88 (d, 2H, J=2.0 Hz), 7.71 (d, 2H, J=8.4 Hz), 7.59 (dd, 2H, J1=8.4 Hz, J2=2.0 Hz), 4.22 (bs, 4H), 3.67 (bs, 4H).

### Synthesis Example 5

In this synthesis example, provided was a red electrochromic material (compound 5) capable of absorbing green light, which had a structural formula as follows:

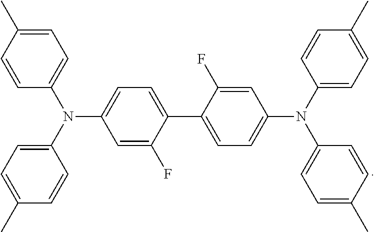 [SMILES: Cc1ccc(N(c2ccc(C)cc2)c2ccc(-c3ccc(N(c4ccc(C)cc4)c4ccc(C)cc4)cc3F)c(F)c2)cc1]

The synthesis procedures of compound 5 were as follows:

0.65 g of 4,4′-dimethyldiphenylamine, 0.57 g of 4,4′-dibromo-2,2′-difluoro-1,1′-biphenyl, and 0.92 g of NaOtBu were added to 30 mL of anhydrous toluene. A resulting solution was bubbled with nitrogen several times, and then 12 mg P(t-Bu)₃ and 14 mg Pd(OAc)₂ were added thereto, and a resulting mixture was refluxed for reaction overnight. After the reaction of raw materials was complete, a resulting system was cooled to room temperature, a resulting organic phase was washed three times with 100 mL of saturated NaCl solution and was distilled under reduced pressure to obtain a crude product, and the crude product was purified by column chromatography (mobile phase: petroleum ether/dichloromethane=1/1) to obtain 0.66 g of compound 5 (yield: 69%).

Characterization data for compound 5: ¹H NMR (400 MHz, DMSO-d₆) δ: 7.71 (m, 2H), 7.47 (s, 2H), 7.15-7.10 (m, 18H), 2.32 (s, 12H).

### Synthesis Example 6

In this synthesis example, provided was a red electrochromic material (compound 6) capable of absorbing green light, which had a structural formula as follows:

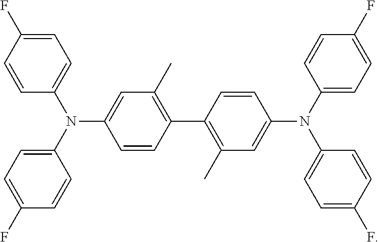 [SMILES: Cc1cc(N(c2ccc(F)cc2)c2ccc(F)cc2)ccc1-c1ccc(N(c2ccc(F)cc2)c2ccc(F)cc2)cc1C]

The synthesis procedures of compound 6 were as follows:

0.68 g of N,N-bis(4-fluorophenyl)amine, 0.56 g of 4,4′-dibromo-2,2′-dimethyl-1,1′-biphenyl, and 0.92 g of NaOtBu were added to 30 mL of anhydrous toluene. A resulting solution was bubbled with nitrogen several times, and then 12 mg P(t-Bu)₃ and 14 mg Pd(OAc)₂ were added thereto, and a resulting mixture was refluxed for reaction overnight. After the reaction of raw materials was complete, a resulting system was cooled to room temperature, a resulting organic phase was washed three times with 100 mL of saturated NaCl solution and was distilled under reduced pressure to obtain a crude product, and the crude product was purified by column chromatography (mobile phase: petroleum ether/dichloromethane=1/1) to obtain 0.59 g of compound 6 (yield: 61%).

Characterization data for compound 6: ¹H NMR (400 MHz, DMSO-d₆) δ: 7.68 (d, 2H, J=7.0 Hz), 7.44 (s, 2H), 7.27 (d, 2H, J=6.8 Hz), 7.18-7.05 (m, 16H), 2.57 (s, 6H).

### Test Example 1

Absorption wavelength test: The maximum absorption wavelength of compound 1 in the colored state is 460 nm, the maximum absorption wavelength of compound 2 in the colored state is 520 nm, the maximum absorption wavelength of compound 3 in the colored state is 518 nm, and the maximum absorption wavelength of compound 4 in the colored state is 516 nm, as measured by using a spectroelectrochemical apparatus. The maximum absorption wavelength of compound 5 in the colored state was measured to be 498 nm. The maximum absorption wavelength of compound 6 in the colored state was measured to be 493 nm.

As can be seen from the above absorption wavelength test results, in the colored state, compounds 1-6 in the synthesis examples of the present disclosure have absorption maxima spanning 445 nm to 520 nm, with compounds 2, 3, and 4 showing higher sensitivity to green light (around 520 nm).

### Example 1

In this example of the present disclosure, an electrochromic medium composition (denoted as electrochromic medium 1) was provided, where a solvent used was a propylene carbonate (PC) solution, and specifically, electrochromic material ingredients were shown in the table below:

| Ingredient | Material | Concentration/mmol |
|---|---|---|
| Anode | 5,10-dimethyldihydrophenazine | 20 |
| Anode | Compound 1 | 20 |
| Cathode | Ethyl viologen | 30 |

### Example 2

In this example of the present disclosure, an electrochromic medium composition (denoted as electrochromic medium 2) was provided, where a solvent used was a propylene carbonate (PC) solution, and specifically, electrochromic material ingredients were shown in the table below:

| Ingredient | Material | Concentration/mmol |
|---|---|---|
| Anode | 5,10-dimethyldihydrophenazine | 20 |
| Anode | Compound 2 | 20 |
| Cathode | Ethyl viologen | 30 |

### Example 3

In this example of the present disclosure, an electrochromic medium composition (denoted as electrochromic medium 3) was provided, where a solvent used was a propylene carbonate (PC) solution, and specifically, electrochromic material ingredients were shown in the table below:

| Ingredient | Material | Concentration/mmol |
|---|---|---|
| Anode | 5,10-dimethyldihydrophenazine | 20 |
| Anode | Compound 3 | 20 |
| Cathode | Ethyl viologen | 30 |

### Example 4

In this example of the present disclosure, an electrochromic medium composition (denoted as electrochromic medium 4) was provided, where a solvent used was a propylene carbonate (PC) solution, and specifically, electrochromic material ingredients were shown in the table below:

| Ingredient | Material | Concentration/mmol |
|---|---|---|
| Anode | 5,10-dimethyldihydrophenazine | 20 |
| Anode | Compound 4 | 20 |
| Cathode | Ethyl viologen | 30 |

### Example 5

In this example of the present disclosure, three electrochromic medium compositions (sequentially denoted as electrochromic media 5a, 5b and 5c, respectively) were provided, where a solvent used was a propylene carbonate (PC) solution, and specifically, electrochromic material ingredients were shown in the table below:

| No. | Material/medium | 5a | 5b | 5c |
|---|---|---|---|---|
| Anode | 5,10-dimethyldihydrophenazine | 20 | | |
| Anode | Compound 1 | 5 | 10 | 15 |
| Anode | Compound 3 | 15 | 10 | 5 |

| | | |
|---|---|---|
| Cathode | Ethyl viologen | 30 |

### Example 6

In this example of the present disclosure, three electrochromic medium compositions (sequentially denoted as electrochromic media 6a, 6b and 6c, respectively) were provided, where a solvent used was a propylene carbonate (PC) solution, and specifically, electrochromic material ingredients were shown in the table below:

| No. | Material/medium | 6a | 6b | 6c |
|---|---|---|---|---|
| Anode | 5,10-dimethyldihydrophenazine | 20 | | |
| Anode | Compound 3 | 20 | | |
| Cathode | Ethyl viologen | 20 | 40 | 60 |

### Example 7

In this example of the present disclosure, three electrochromic medium compositions (sequentially denoted as electrochromic media 7a, 7b and 7c, respectively) were provided, where a solvent used was a propylene carbonate (PC) solution, and specifically, electrochromic material ingredients were shown in the table below:

| No. | Material/medium | 7a | 7b | 7c |
|---|---|---|---|---|
| Anode | 5,10-dimethyldihydrophenazine | 20 | | |
| Anode | Compound 4 | 20 | | |
| Cathode | Methyl viologen | 20 | 40 | 60 |

### Example 8

In this example of the present disclosure, three electrochromic medium compositions (sequentially denoted as electrochromic media 8a, 8b and 8c, respectively) were provided, where a solvent used was a propylene carbonate (PC) solution, and specifically, electrochromic material ingredients were shown in the table below:

| No. | Material/medium | 8a | 8b | 8c |
|---|---|---|---|---|
| Anode | 5,10-dimethyldihydrophenazine | 20 | | |
| Anode | Compound 4 | 10 | 30 | 50 |

| | | |
|---|---|---|
| Cathode | Ethyl viologen | 30 |

### Example 9

In this example of the present disclosure, three electrochromic medium compositions (sequentially denoted as electrochromic media 9a, 9b and 9c, respectively) were provided, where a solvent used was a propylene carbonate (PC) solution, and specifically, electrochromic material ingredients were shown in the table below:

| No. | Material/medium | 9a | 9b | 9c |
|---|---|---|---|---|
| Anode | 5,10-dimethyldihydrophenazine | 0.5 | 25 | 50 |
| Anode | Compound 4 | 0.5 | 25 | 50 |
| Cathode | Ethyl viologen | 1 | 50 | 100 |

### Comparative Example 1

In this comparative example, an electrochromic medium composition (denoted as electrochromic medium A) was provided, where a solvent used was a propylene carbonate (PC) solution, and specifically, electrochromic material ingredients were shown in the table below:

| Ingredient | Material | Concentration/mmol |
|---|---|---|
| Anode | 5,10-dimethyldihydrophenazine | 40 |
| Cathode | Ethyl viologen | 30 |

### Comparative Example 2

In this comparative example, an electrochromic medium composition (denoted as electrochromic medium B) was provided, where a solvent used was a propylene carbonate (PC) solution, and specifically, electrochromic material ingredients were shown in the table below:

| Ingredient | Material | Concentration/mmol |
|---|---|---|
| Anode | 5,10-dimethyldihydrophenazine | 20 |
| Anode | Compound 7 | 20 |
| Cathode | Ethyl viologen | 30 |

The structural formula of compound 7 was as shown below:

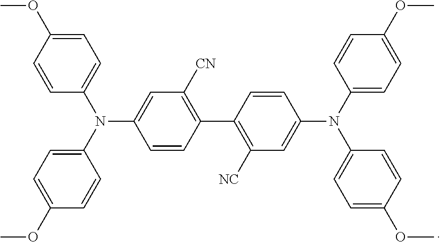

The preparation procedures of compound 7 were shown below:

0.76 g of 4,4′-dimethoxydiphenylamine, 0.6 g of 4,4′-dibromo-[1,1′-biphenyl]-2,2′-dinitrile, and 0.92 g of NaOtBu were added to 30 mL of anhydrous toluene. A resulting solution was bubbled with nitrogen several times, and then 12 mg P(t-Bu)₃ and 14 mg Pd(OAc)₂ were added thereto, and a resulting mixture was refluxed for reaction overnight. After the reaction of raw materials was complete, a resulting system was cooled to room temperature, a resulting organic phase was washed three times with 100 mL of saturated NaCl solution and was distilled under reduced pressure to obtain a crude product, and the crude product was purified by column chromatography (mobile phase: petroleum ether/dichloromethane=1/2) to obtain 0.48 g of compound 7 (yield: 44%).

Characterization data for compound 7 are shown below: ¹H NMR (400 MHz, DMSO-d₆) δ: 7.91 (d, 2H, J=6.4 Hz), 7.65-7.60 (m, 4H), 7.18 (d, 8H, J=6.8 Hz), 6.79 (d, 8H, J=6.2 Hz), 3.81 (s, 12H)

The comparative compound 1 in the colored state has a maximum absorption wavelength measured to be 458 nm and shows very limited absorption of green light due to the introduction of a strongly electron-withdrawing cyano.

### Comparative Example 3

In this comparative example, an electrochromic medium composition (denoted as electrochromic medium C) was provided, where a solvent used was a propylene carbonate (PC) solution, and specifically, electrochromic material ingredients were shown in the table below:

| Ingredient | Material | Concentration/mmol |
|---|---|---|
| Anode | 5,10-dimethyldihydrophenazine | 20 |
| Anode | Compound 8 | 20 |
| Cathode | Ethyl viologen | 30 |

The structural formula of compound 8 was as shown below:

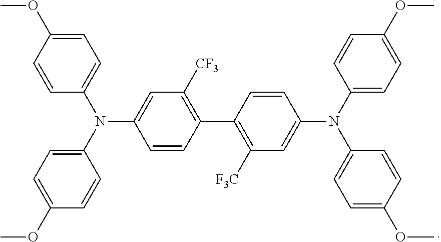

The preparation steps of compound 8 were shown below:

0.76 g of 4,4′-dimethoxydiphenylamine, 0.74 g of 4,4′-dibromo-2,2′-bis(trifluoromethyl)-1,1′-biphenyl, and 0.92 g of NaOtBu were added to 30 mL of anhydrous toluene. A resulting solution was bubbled with nitrogen several times, and then 12 mg P(t-Bu)₃ and 14 mg Pd(OAc)₂ were added thereto, and a resulting mixture was refluxed for reaction overnight. After the reaction of raw materials was complete, a resulting system was cooled to room temperature, a resulting organic phase was washed three times with 100 mL of saturated NaCl solution and was distilled under reduced pressure to obtain a crude product, and the crude product was purified by column chromatography (mobile phase: petroleum ether/dichloromethane=1/2) to obtain 0.5 g of compound 8 (yield: 41%).

Characterization data for compound 8 are shown below: ¹H NMR (400 MHz, DMSO-d₆) δ: 7.75 (s, 2H), 7.67-7.64 (m, 2H), 7.37 (d, 2H, J=6.8 Hz), 7.18 (d, 8H, J=6.3 Hz), 6.79 (d, 8H, J=6.6 Hz), 3.88 (s, 12H)

The comparative compound 2 in the colored state has a maximum absorption wavelength measured to be 454 nm and shows very limited absorption of green light due to the introduction of a strongly electron-withdrawing trifluoromethyl.

### Test Example 2

The electrochromic medium compositions provided in the above examples and comparative examples were tested, specifically, for the L, a, and b values at a voltage of 1.2 V. The results are shown in the table below:

| Electrochromic medium | L | a* | b* |
|---|---|---|---|
| Example 1 | 24.94 | −7.31 | 8.89 |
| Example 2 | 22.67 | −6.79 | 6.41 |
| Example 3 | 24.36 | 2.54 | 2.67 |
| Example 4 | 23.51 | 4.03 | 3.15 |
| Example 5a | 22.14 | 1.51 | 1.73 |
| Example 5b | 23.72 | 0.83 | 1.97 |
| Example 5c | 23.60 | 1.88 | 2.75 |
| Example 6a | 35.12 | −12.57 | 12.81 |
| Example 6b | 20.15 | 3.12 | −2.91 |
| Example 6c | 19.98 | 3.07 | −2.23 |
| Example 7a | 34.65 | −13.19 | 11.32 |
| Example 7b | 21.03 | 3.42 | −3.06 |
| Example 7c | 20.69 | 3.17 | −5.31 |
| Example 8a | 25.11 | −2.98 | 3.37 |
| Example 8b | 24.73 | 2.33 | 3.19 |
| Example 8c | 23.35 | 2.49 | 2.07 |
| Example 9a | 80.12 | 2.98 | 9.37 |
| Example 9b | 17.32 | 3.74 | 2.91 |
| Example 9c | 3.35 | 2.45 | 1.75 |
| Comparative example 1 | 26.13 | −30.31 | 3.12 |
| Comparative example 2 | 24.94 | −4.31 | 5.89 |
| Comparative example 3 | 25.43 | −5.86 | 4.59 |

It should be noted that the L*, a*, and b* in the Lab color space respectively represent the lightness, green-red chromaticity, and blue-yellow chromaticity of the color. A higher L* indicates greater brightness of the color. When a*>0, the color belongs to the red system, and a larger a* value indicates a greater red intensity; when a*<0, the color belongs to the green system, and a smaller a* value indicates a greater green intensity. When b*>0, the color belongs to the yellow system, and a larger b* value indicates a greater yellow intensity; when b*<0, the color belongs to the blue system, and a smaller b* value indicates a greater blue intensity.

As can be seen from the above table, the system consisting of 5,10-dimethyldihydrophenazine and ethyl viologen exhibits a highly negative a* value, resulting in a green-colored state. When compounds 1-4 provided in the examples of the present disclosure are introduced, the a* values are significantly adjusted and controlled, and in particular, the combination of compounds 1 and 3 (Examples 5a-5c) exhibit the most effective adjustment and control of the a* value (approaching 0) of the system, achieving a colored state closest to “neutral gray”. Due to the introduction of a strongly electron-withdrawing group, the colored states of comparative compound 1 and comparative compound 2 are close to orange, which also deviates from the “neutral gray”. This demonstrates the advantage of the electrochromic medium compositions provided by the examples of the present disclosure. By introducing a red anodic electrochromic material capable of absorbing green light, the device can exhibit neutral gray in the colored state.

### Use Example

Two pieces of ITO-coated glass (40*40*0.4 mm) were aligned with offset edges and bonded with dispensed adhesive. The device case had a thickness of 125 microns. The prepared electrochromic device was filled with a solution prepared by mixing the materials above by means of vacuum liquid filling. With a voltage applied at both ends, the transmittance data for the electrochromic medium composition of comparative example 1 and the electrochromic medium composition of example 3 were measured at a voltage in a range of 0 to 1.2 V and a wavelength of 550 nm. The results are shown in the table below:

| Applied | Comparative | |
|---|---|---|
| voltage/V | example 1 | Example 3 |
| 0.0 | 88.3 | 87.1 |
| 0.2 | 85.1 | 85.5 |
| 0.4 | 80.9 | 79.7 |
| 0.6 | 73.1 | 63.1 |
| 0.8 | 62.6 | 44.2 |
| 1.0 | 49.2 | 29.9 |
| 1.2 | 35.5 | 16.5 |

As can be seen from the above table, the electrochromic medium composition of comparative Example 1 (no red anode material) has a poor absorption capacity for light at 550 nm in the colored state thereof, and after the introduction of the red anode material compound 3, the transmittance is significantly lower, indicating that the addition of compound 3 provided in the example of the present disclosure enhances the effective absorption of green light by the device. It can be seen that the perfect adjustment of the “neutral gray” is achieved by introducing the red anode material capable of absorbing green light provided in the example of the present disclosure into the dimethylphenazine-viologen system, thus enabling the electrochromic device to achieve full coverage of the visible light spectrum.

The embodiments described above are merely preferred embodiments of the present disclosure, and are not intended to limit the present disclosure. For those skilled in the art, various changes and variations may be made to the present disclosure. Any modifications, equivalent substitutions, improvements, etc., made within the spirit and principles of the present disclosure shall be included within the scope of the present disclosure.

What is claimed is:

1. An electrochromic medium composition, comprising at least two anodic electrochromic materials and one cathodic electrochromic material, wherein
a molar ratio of the at least two anodic electrochromic materials to the one cathodic electrochromic material is in a range of 1:0.5 to 1:1.5;
the one cathodic electrochromic material comprises an electrochromic material capable of absorbing yellow light;
the at least two anodic electrochromic materials comprise an electrochromic material capable of absorbing blue light and red light and an electrochromic material capable of absorbing green light, and the electrochromic material capable of absorbing the green light is selected from compounds represented by the following structural formula: 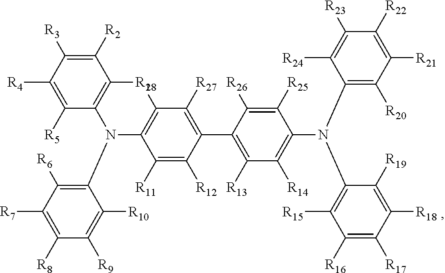
wherein R₁ to R₂₈ are each independently any one selected from the group consisting of hydrogen, halogen, cyano, nitro, C1-C5 substituted or unsubstituted alkyl and OR′, or R₁₂ and R₁₃ link together to form a first ring, or R₂₆ and R₂₇ link together to form a second ring, wherein R′ is any one selected from the group consisting of C1-C5 unsubstituted alkyl, C6-C10 aryl, and amino; and
a molar ratio of the electrochromic material capable of absorbing the blue light and the red light to the electrochromic material capable of absorbing the green light is in a range of 1:0.5 to 1:2.5.

2. The electrochromic medium composition of claim 1, wherein R₁ to R₂₈ are each independently any one selected from the group consisting of H, F, Cl, Br, I, CN, the OR′, NO₂ and C1-C3 unsubstituted alkyl, the R′ being any one selected from the group consisting of C1-C3 unsubstituted alkyl, C6-C10 unsubstituted aryl, and amino;
or R₁₂ and R₁₃ link together to form the first ring, and the first ring comprises a first oxygen-containing heterocycle;
or R₂₆ and R₂₇ link together to form the second ring, and the second ring comprises a second oxygen-containing heterocycle.

3. The electrochromic medium composition of claim 1, wherein the electrochromic material capable of absorbing the green light is any one selected from the group consisting of compounds represented by the following structural formulae:

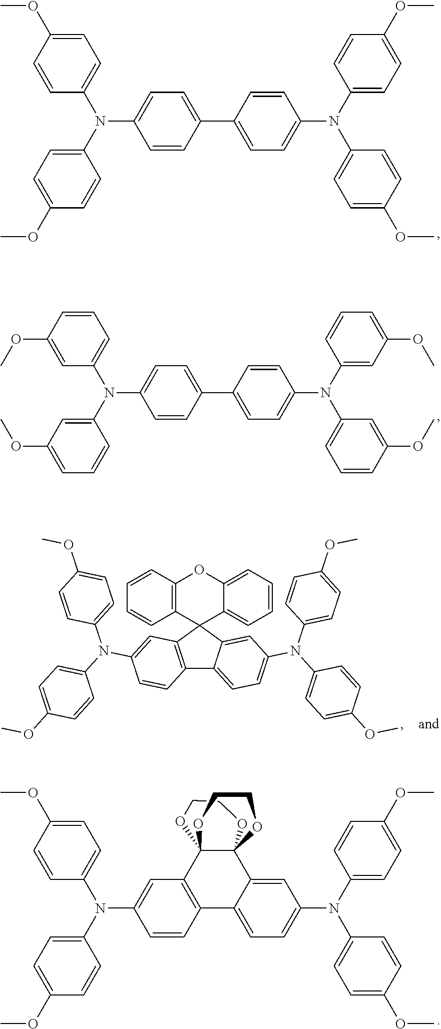

4. The electrochromic medium composition of claim 1, wherein the electrochromic material capable of absorbing the blue light and the red light is selected from a phenazine-based electrochromic material; and
the electrochromic material capable of absorbing the yellow light is selected from a viologen-based electrochromic material.

5. The electrochromic medium composition of claim 1, wherein the electrochromic material capable of absorbing the blue light and the red light is 5,10-dimethyldihydrophenazine; and
the electrochromic material capable of absorbing the yellow light is ethyl viologen.

6. The electrochromic medium composition of claim 1, wherein a molar ratio of the electrochromic material capable of absorbing the blue light and the red light to the electrochromic material capable of absorbing the green light is in a range of 1:1.5 to 1:1.8.

7. The electrochromic medium composition of claim 1, wherein a concentration of the at least two anodic electrochromic materials in the electrochromic medium composition is in a range of 1 mM (millimolar) to 100 mM, and a concentration of the one cathodic electrochromic material in the electrochromic medium composition is in a range of 1 mM to 100 mM.

8. A method for preparing the electrochromic medium composition of claim 1, comprising mixing the at least two anodic electrochromic materials and the one cathodic electrochromic material.

9. The method of claim 8, wherein the electrochromic material capable of absorbing the green light is synthesized with reference to the following synthesis route: 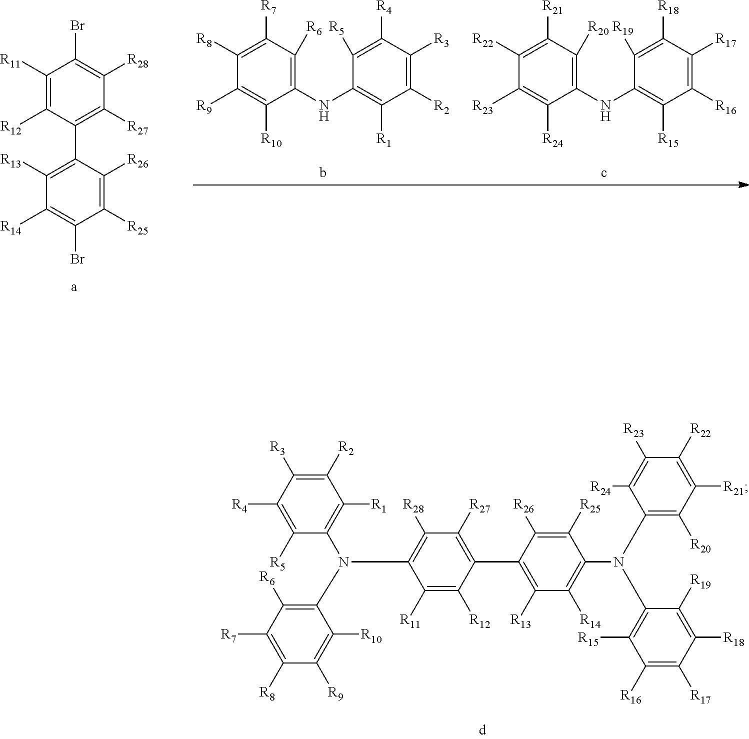
wherein feeding amounts of reaction materials are as follows: 1 equivalent of compound a, 1 equivalent to 1.1 equivalents of compound b, 1 equivalent to 1.1 equivalents of compound c, 2.0 equivalents to 2.5 equivalents of a sodium alkoxide material, 0.02 equivalents to 0.05 equivalents of alkylphosphine, and 0.005 equivalents to 0.02 equivalents of a palladium catalyst; and
a reaction temperature is in a range of 100° C. to 120° C.

10. An electrochromic device, comprising the electrochromic medium composition of claim 1.
